(19) United States
(12) Patent Application Publication
(10) Pub. No.: US 2002/0174636 A1
(43) Pub. Date: Nov. 28, 2002

(54) Corn head conveying system

(76) Inventor: Marion Calmer, Alpha, IL (US)

Correspondence Address: Rockey, Milnamow & Katz, Ltd., Two Prudential Plaza, 47th Floor, Chicago, IL, 60601, US

(21) Appl. No.: 09/865,042

(22) Filed: May 24, 2001

(51) Int. Cl. A01D 34/00

(52) U.S. Cl. 56/14.5

(57) ABSTRACT

The novel invention provides a smooth, continuous, positive uninterrupted flow of more material with less congestion and even feeding of the harvested crop from the row unit to the cross auger to the retrieving area of the feeder house. More efficient harvesting at higher speeds is now possible in both ideal and adverse conditions. This novel corn harvesting unit strategically shapes the floor of the lateral conveying chamber as a convex, non-radius or nonconcaved surface. The new floor surfaces more nearly conform to the natural glide path of the material exiting the row units while retaining maximum allowable elevation imparted by the row units or a first conveyor system. The novel arrangement of floor, planes and added novel directional vanes combined with a changed spatial relationship between the powered and umpowered conveying chambers or systems will also encourage the harvested material to better disengage from the transverse cross auger flighting and change direction.

### BACKGROUND OF THE INVENTION

This invention relates to corn harvesting machinery, specifically the spatial relationship between the exit area of the row unit, components of the lateral conveying system, and the retrieving area of the feeder house. This invention also relates to the shape of the floor of the conveying chamber, and its emulation of the natural flight path of harvested material exiting from the row unit.

The corn header of the existing art contains a plurality of row units to strip and separate the ears from the stalk, a conveying chamber consisting of a cross auger and trough or concaved floor for delivering harvested material to the feeder house. The combine feeder house of the existing art contains a chain slat undershot conveying system for retrieval of harvested material from said corn head and delivery to the threshing system.

The crop dividers in combination with the gathering chain(s) and stripper plates in the prior art have retrieved the crop from near ground level into the row units. The stripper plates in combination with the stalk rolls will strip and separate the ears with minimal amounts of mog (material other than grain). Said gathering chain(s) then feed the heterogeneous material (ears and mog) into the cross auger and trough. The cross auger is located laterally between the exit point of the row units and the retrieving point of the feeder house. The cross auger then delivers this material to the feeder house for conveying to the combine for ultimate threshing and separating. This results in large volumes of material being transferred three times by three conveying systems in two different directions.

The first stage of the material transferring process is at the exit of the row unit where there is adequate power and crop engagement by the gathering chain and fingers for material deliverance into the cross auger and trough where it now makes a ninety degree (90°) change in direction. The cross auger has flighting on it, which applies power to the material horizontally in the cross auger trough, thus changing the motion which was in line with the combine and the row unit to a lateral movement to the exit area of the cross auger trough.

The second stage of material transfer is at the exit area of the corn head lateral conveying chamber and is accomplished by the combination of the transverse cross auger flighting and trough. This material transfer occurs as a result of material being contained against the floor and transferred to the feeder house by the cross augers flighting. The two lateral sections of the cross auger flighting are oppositely wound and meet in the middle. The horizontal movement of the crop from the right side and the left side of said cross auger chamber meet and create a mass to be transferred to the feeder house.

At the entrance to the feeder house, the back vertical wall of the cross auger trough, is removed so that the material may be fed from the cross auger floor into the feeder house. Most of the energy imparted to the mass of material assembled at this entrance causes the material to make a ninety-degree (90°) change in direction toward the feeder house.

This movement is imparted by the cross auger rotation but is applied at the point of exit to push the mass of material up a severe inclined plane. Force is no longer directly imparted to the inert material after leaving the cross auger, which creates a dead space or area of unforced movement. The material must have adequate energy imparted to propel the crop up this severe inclined plane to the retrieving area of the feeder house, where it is then conveyed by the undershot chain slat conveyor system.

The third stage of material transfer is at the exit area of the feeder house where the chain slat conveyor delivers harvested material to the receiving area of the threshing system.

### LIMITATIONS OF THE PRIOR ART

In the past thirty years at least two things related to corn production have changed. 1. Yields have doubled through improved genetics, fertilization, populations, and row spacings. 2. Harvesting machines are larger with increased horsepower, ground speeds, and bigger appetites that require corn headers with more row units. These two factors in combination have significantly increased the flow rate, through put, or mass of material being transferred from ear separation through the corn head, to the threshing system.

In the prior art, the material exiting the first conveyor system loses some of its elevation or energy that was imparted to the mass of material as it is forced downward into the second conveyor system. The center of the cross auger tube and flighting are partially inline with the path of the material exiting the row unit, which also causes congestion.

The prior art also limits material flow because the aft portion of the cross auger tray in the lateral conveying chamber directly in front of the feeder house, forms a sever inclined plane. This inclined plane encourages the harvested material to stay engaged with the cross auger flighting over running its respective exit window and colliding with the material which is over running its respective exit window from the opposite side of said conveyor. This creates a large mass that is pyramidal or conical in shape, which is to be transferred to the feeder house. This shape and size of mass over loads the center portion and under loads the outer portion of the undershot chain slat conveyor.

The prior art has limitations because the flow pattern of material is making ninety-degree (90°) turns through dead energy spaces, and simultaneously moving up or down inclined planes. The mass of material therefore tends to decelerate and pile up in the first and second conveyor systems as material pushes against material. This causes build up, back feeding, tossing of mog onto the deck covers (fluff), tossing of ears onto the ground, and plugging in the cross auger and conveying chambers. These factors inhibit the conveyor systems ability to reach maximum loading capabilities.

### BRIEF SUMMARY OF THE INVENTION

This invention provides for improved corn head performance i.e., smooth continuous flow of more material with less congestion and more even feeding of the harvested crop to the feeder house conveyor.

This invention strategically shapes the floor of the lateral conveying chamber as a convex non-radius or non-concave surface that more nearly conforms to the natural glide path of the material exiting the row unit. The floor in combination with the invention described and claimed in my co-pending application Ser. No. 09/827,563 and shown in FIG. 4a can theoretically retain up to 100 percent of the elevation imparted to the material exiting the row unit. The floor also in the same combination can theoretically reduce up to 100 percent of the angle of the inclined plane from the exit area of the corn head to the retrieving point of the chain slat feeder house conveyor. This arrangement of floors, planes and directional vanes encourages the harvested material to disengage from the cross auger flighting change direction and decrease the harvested materials tendency to overrun its respective exit window of the corn head as it is conveyed laterally down the conveying chambers.

This invention replaces the flighting on the cross auger, directly in front of the feeder house, with moving members such as detachable paddles or retractable fingers. This provides an impediment to the harvested materials tendency to overrun its respective exit window of the corn head as it is conveyed laterally down the conveying chamber.

This invention also provides for vertically raising the cross auger in respect to the first conveyor system for increased intake of harvested material which has broken loose from the first conveyor system and is floating above the row unit deck covers. This is often the case in harvesting lodged or wind blown corn.

This invention also reduces the size of the center tube of the cross auger which provide for reduced amounts of material, colliding with the tube as it exits the row unit.

This invention provides that the force and energy required to move the material from the exit point of the conveying chamber floor through a dead space or unforced movement to its retrievable position in the feeder house is reduced.

This invention provides that the shape of the mass of the harvested material being fed to the retrieving point of the feeder house chain slat undershot conveyor system more nearly conforms to the shape of the conveying chamber.

This invention increases the amount of material the feeder house chain and slat conveyor can successfully retrieve. This material is to be carried to the threshing system. The same energy imparted by the cross auger will now move more harvested material faster through the dead space to the feeder house conveyor.

The invention provides for improved corn head performance i.e., smooth continuous positive increased flow of more material with less congestion and more even feeding of the harvested crop from row unit to the feeder house conveyor. Until this invention and my invention disclosed and claimed in co-pending patent application Ser. No. 09/827,563, there has been little improvement in this area of total material flow through corn heads.

### DESCRIPTION OF THE DRAWINGS

FIG. 1—is a side view of a combine with a corn head attached.

FIG. 2—is a top view of the corn head with feeder house attached, cross auger and row units of prior art.

FIG. 3—is a sectional view A-A of FIG. 2 of the row unit, cross auger, trough, feeder house, and conveyor of the prior art.

FIG. 4—is a sectional view A-A of FIG. 5 of the row unit, cross auger, flat or convex floor, feeder house, and conveyor of the present invention.

FIG. 4a—is a sectional view A-A of FIG. 5 of present invention plus realignment spacers and feeder plate.

FIG. 5—is a front view of the corn head with the cross auger flighting replaced in front of the feeder house area by detachable paddles.

FIG. 6—is a front view of the corn head with directional vanes and the cross auger flighting replaced in front of the feeder house area by retractable fingers.

FIG. 7—is a sectional view D-D of FIG. 2 of the row unit, cross auger, trough, back wall, and feeder house of the prior art.

FIG. 8—is a sectional view D-D of FIG. 5 of the row unit and feeder house with modifications to the back wall of the lateral cross auger conveying chamber.

FIG. 9—is an end view C-C of the header of FIG. 5 showing the novel cross auger bearing bracket which allows for independent vertical and horizontal adjustments of said auger.

### DETAILED DESCRIPTION OF THE INVENTION

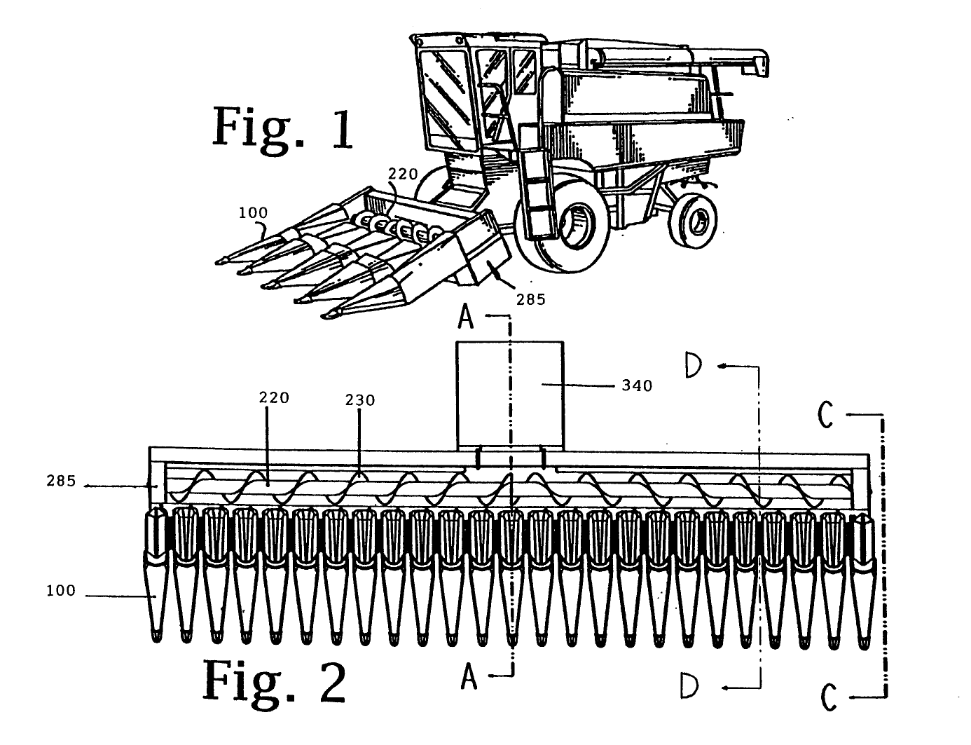

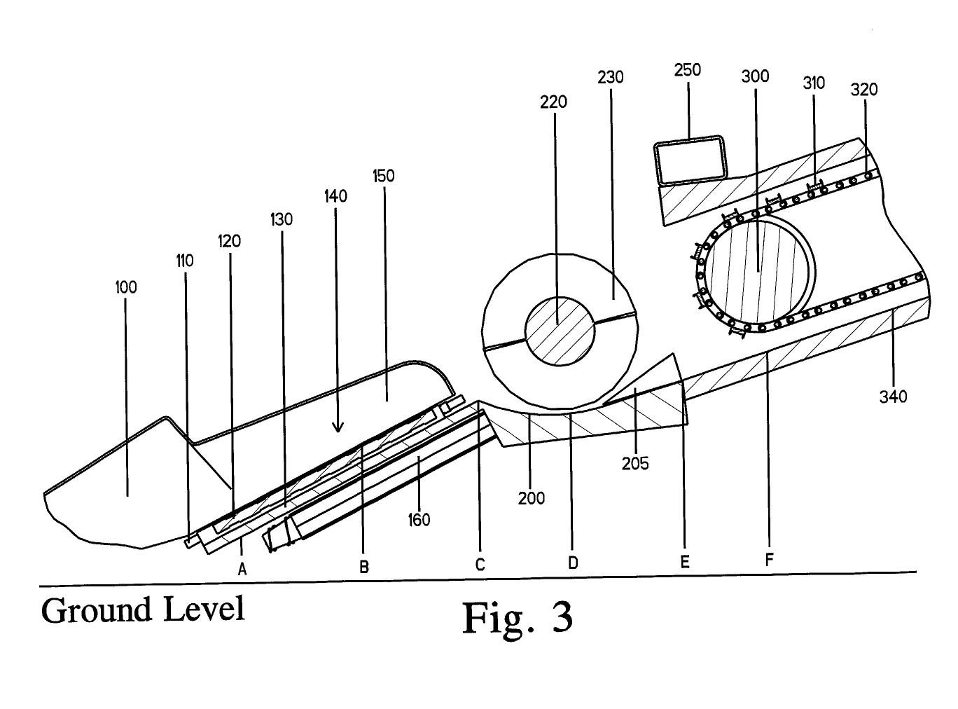

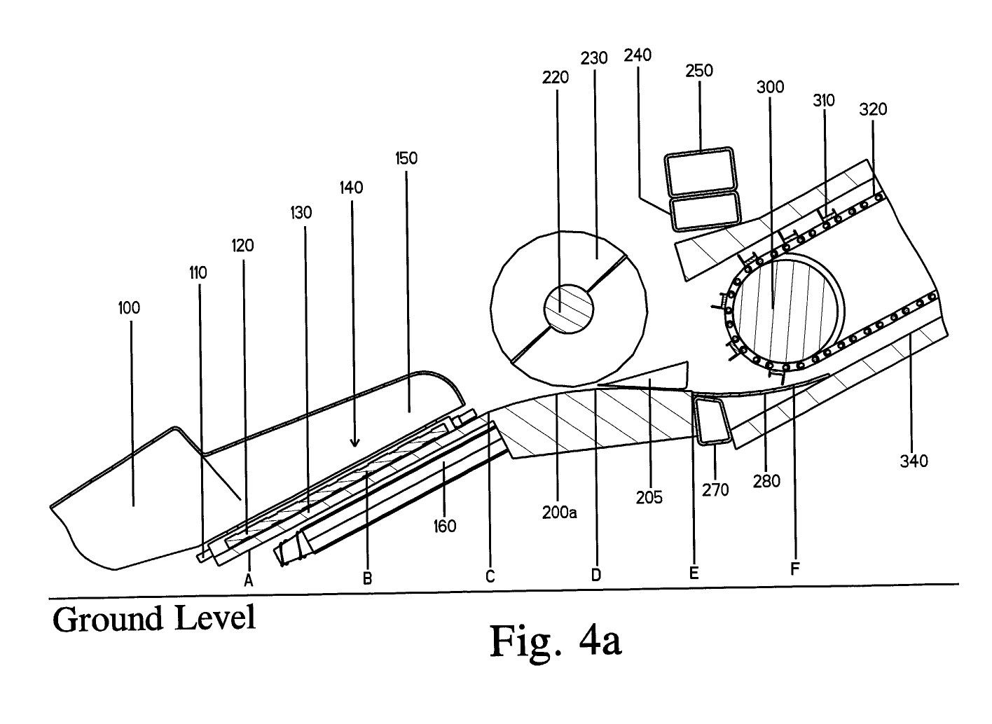

The operations of corn heads of the prior art are illustrated in FIGS. 1, 2, 3, and 7. The operations of corn heads incorporating this invention are shown in FIGS. 4, 4a, 5, 6, 8, and 9.

In FIGS. 1, 2, 3, and 7 the corn stalks are engaged by the gathering chains 120 guided into the snapping slots 140 formed by stripper plates 130. The snapping rolls 160 pull the corn stalks through the snapping slots 140 and the ears are removed from the stalks at point B, as they come into engagement with the stripper plates 130. The ears are then carried rearwardly and upwardly by the gathering chain fingers 110 and deposited in the trough 200 that contains the auger 220 with flighting 230. The crop must proceed from point A, up the inclined plane by the power imparted to it by the gathering chains 120 through point B to point C where the crop is deposited into the auger trough 200 for lateral movement to the exit point area E of the auger trough 200 by the auger 220 having flighting 230 thereon. The power to drive the gathering chains 120 and the snapping rolls 160 is provided from a main drive shaft through a gear box as described in the prior art.

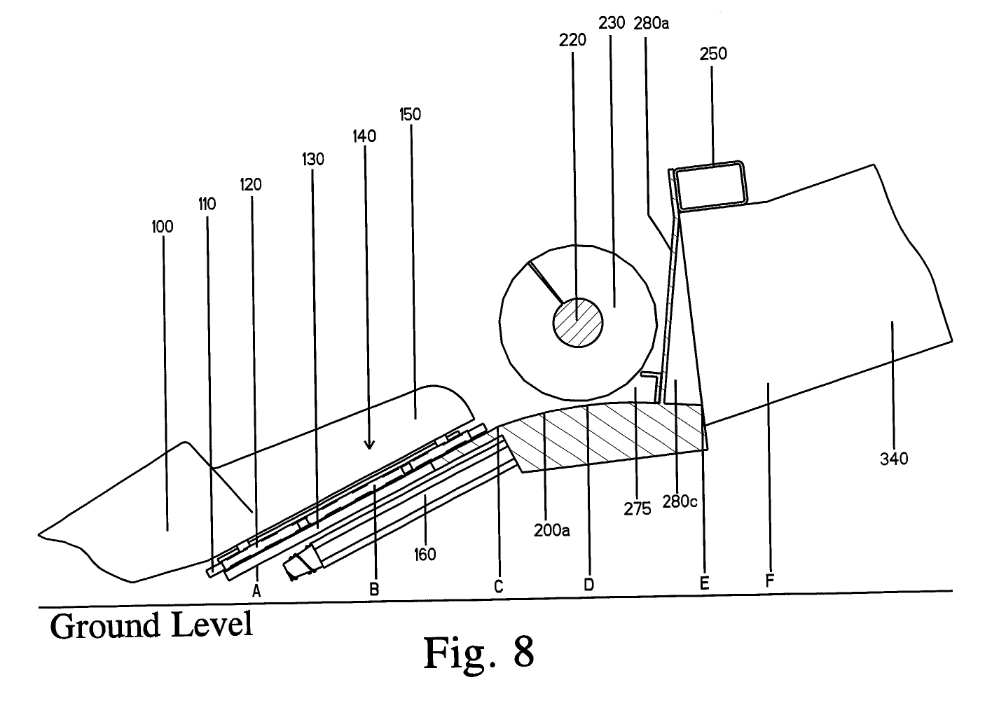

This invention as shown in FIGS. 4, 4a, and 8 strategically reshapes the conveying chamber floor 200a or 200b of the lateral conveying chamber 275 so as to retain the maximum amount of elevation which was imparted to the harvested material by gathering chain fingers 110. This strategically shaped conveying floor better emulates the natural flight path of said exiting material at point C. The energy imparted to the harvested material exiting the row unit at point C is adequate to move it to point D for conveying. Point D is equal to or higher than point C when the corn header is in its normal operating position i.e., approximately two inches at point A.

This invention as shown in FIGS. 4a and 8 has the diameter of the cross auger tube 220 reduced so as to avoid interference with the material exiting the row unit from gathering chains 120.

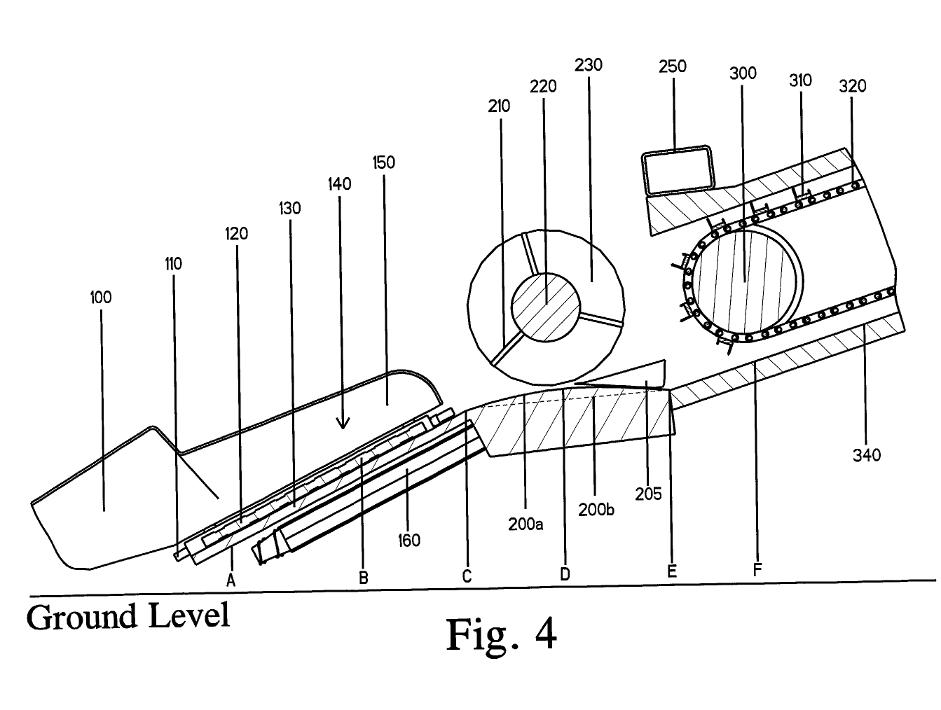

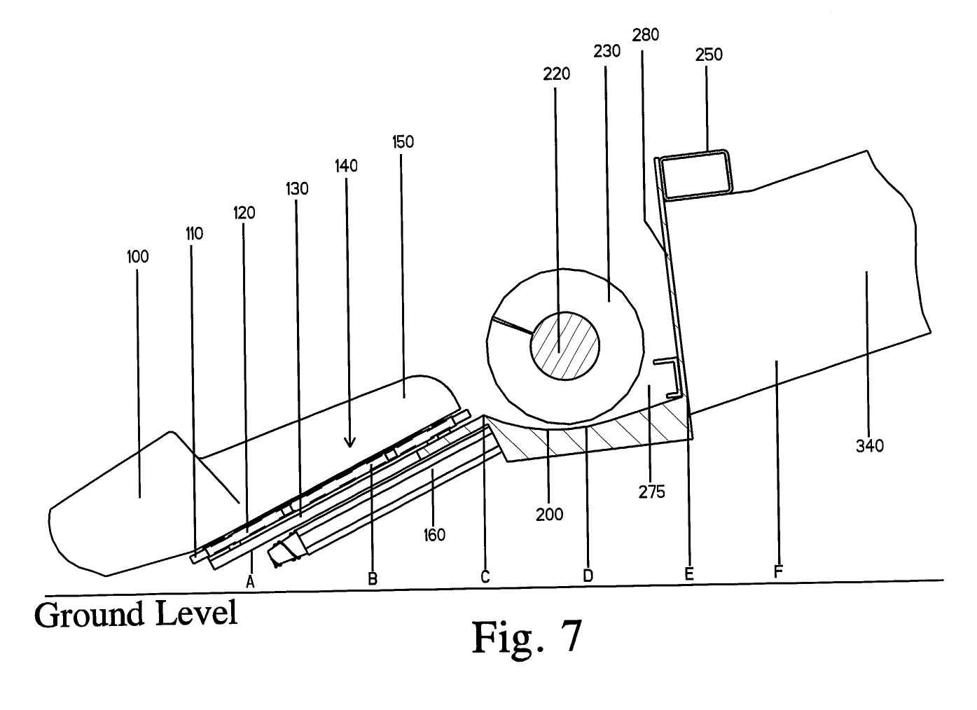

In FIGS. 3 and 7 of the prior art the rotational movement of flighting 230 partially repels any dislodged or broken harvested material flowing toward the conveying chamber on the deck covers 150. This occurs because the rotation of flighting 230 forces the floating material away from the conveying chamber 270.

In FIG. 4, 4a, and 8 the strategic reshaping of the conveying floor 200a or 200b and the raising of the cross auger tube 220 will increase the retrieving ability of cross auger flighting 230 relative to the dislodged harvested material that is floating on the deck covers 150. This occurs because of the suction and motion of flighting 230 is now in line with the desired direction of travel of the dislodged material.

In FIG. 4a the realignment spacers 240, 270 and the feeder plate 280 are shown and function to move the first and second conveying systems vertically and horizontally with respect to the third conveying system. Further description can be found in my co-pending patent application Ser. No. 09/827,563.

In FIGS. 1-8 energy is imparted by flighting 230 to the material i.e., the ears of corn plus mog which then are moved rearwardly and laterally.

In FIG. 8 the proper size of the conveying chamber 270 is maintained by the insertion of filler plate 280c which realigns the back wall relative to the new location of the cross auger 220.

In the prior art the conveyor chamber has its vertical back wall removed when it is opposite the feeder house 340 and the feeder house chain 320. Thus in FIG. 3 the material has had some energy imparted to it from the gravitational movement from point C to point D, which is the low point of the travel of the material in the cross auger trough 200. Now the material must be, as shown in FIG. 3 forced by the cross auger flighting 230 from point D over the edge of the cross auger trough 200 at point E to the retrieving point F of the feeder house 340. The feeder house chain 320 can not be too close to the cross auger flighting 230 because of the interference which would result from two parts moving in opposite directions and powered for such movement.

Thus the material, which has accumulated at the exit point, is forced laterally i.e., rearwardly up the inclined plane by the motions of the flighting 230. This rearward motion must overcome gravity, friction, and the weight of the material being pushed by a force that is opposite of movement desired.

As shown in FIGS. 4, 4a, 5, and 6 the conveying chamber has its vertical back wall 280a removed when it is opposite the feeder house 340 and the feeder house chain 320. Thus in FIGS. 4 and 4a the material is moved to point D, the high point of travel, by the energy from gathering chain fingers 110. Now the material must be as shown in FIGS. 4 and 4a forced by the cross auger flighting 230 or paddles 210 or retractable fingers 211 from point D, across point E, across the conveying floor 200a or 200b, to the retrieving point F of the feeder house 340.

This invention as shown in FIG. 4, 4a and 8 strategically reshapes the conveying floor 200a or 200b and chamber 275. This reshaped convex 200a or flat 200b floor provides for increased material flow with the same energy for propelling the crop or assisting in propelling the crop in its movement from the conveying floor to the feeder house 340 where it is engaged by the feeder house chain 320 and slats 310 for further powered movement.

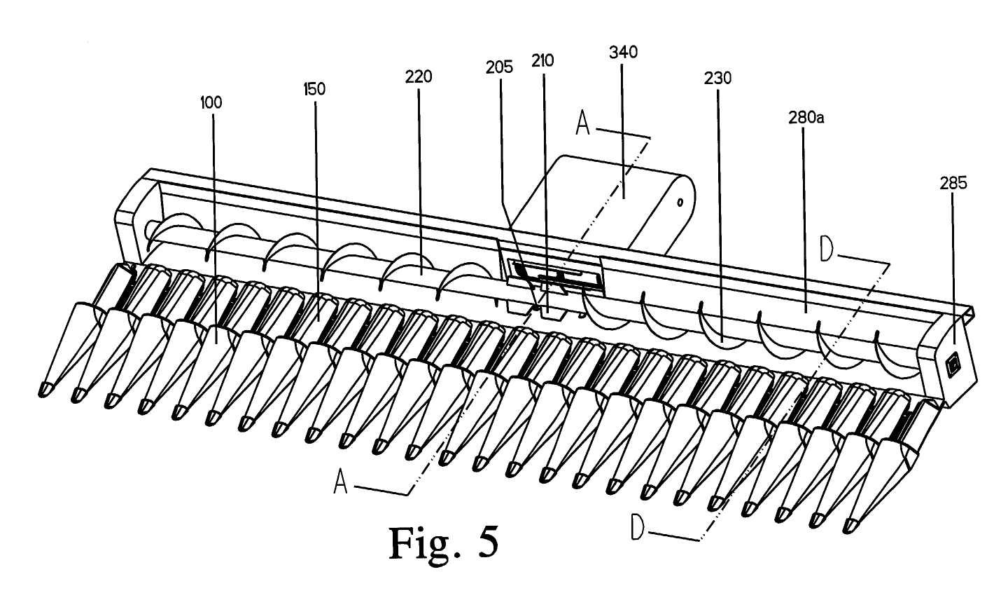

In FIG. 5 the center portion of flighting 230 is replaced by detachable paddles 210. This eliminates further application of lateral energy to the ears and mog that are traveling laterally down the conveying chamber 275 and assists them in making a perpendicular change in direction at the exit area of the corn head.

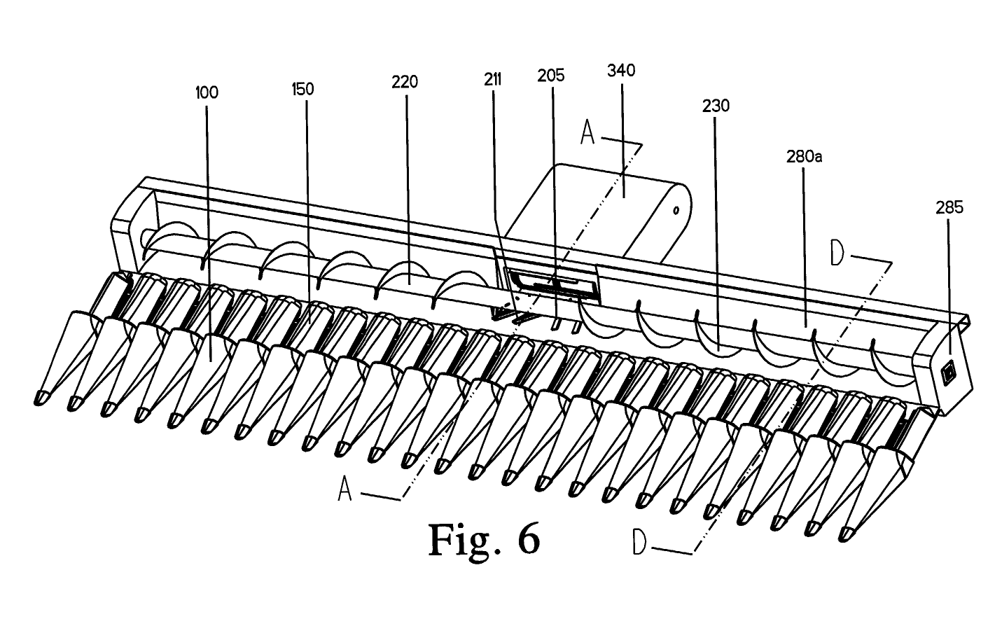

In FIG. 6 the center portion of flighting 230 is replaced by retractable fingers 211. This eliminates further application of lateral energy to the ears and mog that are traveling laterally down the conveying chamber 275 and adds energy to make a perpendicular change in direction at the exit area of the corn head and to be propelled to the retrieving area of the feeder house 340.

In FIGS. 3, 4, 4a, 5 and 6 the floor of the second conveyor system is shown with a plurality of directional vanes 205, which is preferably curved as shown, at least one vane is required to assist in altering the path of the material to exit the floor 200, 200a or 200b of the second conveyor system and enter the retrieving area 340 of the third conveyor system.

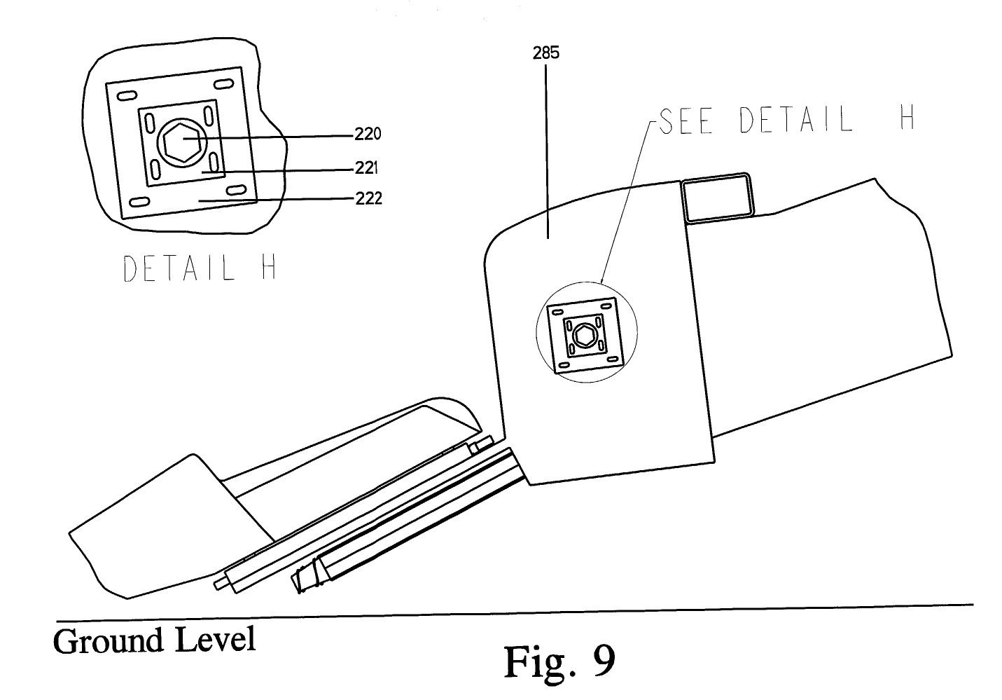

In FIG. 9 the bearing hanger or brackets 221 & 222 have been improved or modified to allow vertical movement independently of horizontal movement so as to allow precise adjustment of the cross auger tube 220 for improved performance.

Having described the preferred embodiment, other features of the present invention will undoubtedly occur to those versed in the art, as will numerous modifications and alternations in the embodiments of the invention illustrated, all of which may be achieved without departing from the spirit and scope of the invention as defined in the appending claims.

What is claimed is:

1. An arrangement of the spatial relationship between the functional elements of a row crop harvester attachment for mounting on and co-acting with the functional elements of a mobile threshing unit comprising:
a) a row crop harvester having a main frame attachment mounted on a mobile harvesting threshing unit;
b) a first conveyor system in said row crop harvester including a power source, said power source connected to a plurality of row units mounted on said main frame for removing the ear from stalks and conveying harvested material up a first inclined plane to exit from said first conveyor system;
c) a second conveyor system, at right angles to said first conveyor system, including a power source, for receiving the harvested material from the exit of said first conveyor system;
d) said second conveyor system conveying said harvested material from the exit of said first conveyor system to an area at the center of the plurality of row units of said first conveyor system for exit from said second conveyor system;
e) said second conveyor system having a horizontal floor, said floor being convex relative to the ground;
f) the inclined plane surfaces of the floor at the entrance to and the exit from said second conveyor system are inclined and in opposite directions when said second conveyor system is parallel to the ground;
g) a third conveying system including an entrance portion and a power source in said mobile threshing unit for retrieving material in said entrance portion and delivering the material to the thresher mechanism.
h) an open area in said entrance portion including an inclined plane connecting the exit of the second conveying system to entrance of third conveying system;

2. The invention in accordance with claim 1 wherein said horizontal floor is flat;

3. The invention in accordance with claim 1, wherein said second conveying system includes an auger with flighting thereon.

4. The invention in accordance with claim 3, wherein said auger flighting is reversed on opposite sides of the centerline of said auger and ends at the center of said auger.

5. The invention in accordance with claim 4 wherein said flighting ends opposite said entrance to said third conveyor system, and paddles replace said flighting at said center section.

6. The invention in accordance with claim 4, wherein said flighting ends opposite said entrance to said third conveyor system, and retractable fingers replace said flighting at said center section.

7. The invention in accordance with claim 1, wherein said first and second conveyor systems are moved vertically upwardly with relation to said third conveying system to reduce the angle of transition between the exit of said second conveying system to the entrance of said third conveying system.

8. The invention in accordance with claim 1, wherein said second conveyor system is moved vertically upwardly with relation to said third conveying unit to reduce the angle of transition between the exit of said second conveying system to the entrance of said third conveying system.

9. The invention in accordance with claim 1, wherein horizontal lateral adjustment of said first and second conveyor systems with respect to said third conveyor system moves the connection of the first and second conveyor system relative to the third conveyor system in the mobile threshing unit to improve the angle between the exit of said second conveyor system to the entrance of said third conveying system.

10. The invention in accordance with claim 1, wherein horizontal adjustment of said first and second conveyor systems with respect to third conveyor system reduces the distance between exit from said second conveyor system to the open retrieval area of said third conveyor system.

11. The invention in accordance with claim 7 where in said vertical movement between said first and second conveyor systems and said third conveying system is provided by insertion of a spacer element.

12. The invention in accordance with claim 9, wherein said horizontal adjustment between said first and second conveyor systems with respect to said third conveyor system is provided by insertion of a spacer element.

13. The invention in accordance with claim 11, wherein the spacer is rectangular in shape.

14. The invention in accordance with claim 7, wherein a plate is attached to said second conveyor unit bridging vertically the open space between said second conveyor unit and said third conveyor unit.

15. The invention in accordance with claim 9, wherein the horizontal movement between said second and said third conveyor systems causes a trapezoid void between said first and second conveyor system.

16. The invention in accordance with claim 14 wherein said plate is made of elastomeric material to conform to variations in movement between the second and third conveying units.

17. The invention in accordance with claim 15 wherein a plate added at the side of said second conveying unit, to fill the void between the second conveyor system and the third conveying system.

18. The invention in accordance with claim 8, wherein a vertical plate is attached to said second conveyor unit bridging horizontally the open space between said second conveyor unit and said third conveyor unit.

19. The invention in accordance with claim 3, wherein said auger is independently adjustable, horizontally and vertically within said second conveyor system.

20. An arrangement of the spatial relationship between the functional elements of a row crop harvester attachment for mounting on and co-acting with the functional elements of a mobile threshing unit comprising:
a) a row crop harvester having a main frame attachment mounted on a mobile harvesting threshing unit;
b) a first conveyor system in said row crop harvester including a power source, said power source connected to a plurality of row units mounted on said main frame for removing the ear from stalks and conveying harvested material up a first inclined plane to exit from said first conveyor system;
c) a second conveyor system, at right angles to said first conveyor system, including a power source, for receiving the harvested material from the exit of said first conveyor system;
d) said second conveyor system conveying said harvested material from the exit of said first conveyor system to an area at the center of the plurality of row units of said first conveyor system for exit from said second conveyor system;
e) said second conveyor system having a horizontal floor;
f) said horizontal floor having at least one directional vane opposite the entrance area to said third conveyor system;
g) the inclined plane surfaces of the floor at the entrance to and the exit from said second conveyor system are inclined and in opposite directions when said second conveyor is parallel to the ground;
h) a third conveying system including an entrance portion and a power source in said mobile threshing unit for retrieving material in said entrance portion and delivering the material to the thresher mechanism.
i) an open area in said entrance portion including an inclined plane connecting the exit of the second conveying system to entrance of third conveying system.

21. The invention in accordance with claim 20, wherein said second conveyor system includes an auger with flighting thereon having a center tube diameter which increases the effective force applied by the flighting to convey the material in said second conveyor system.

22. The invention in accordance with claim 20, wherein said floor of said system second conveyor at said center exit area includes a plurality of directional vanes.

23. The invention in accordance with claim 20, wherein said second conveyor system includes a plurality of paddles at said center exit area to force said material to said third conveying system.

24. The invention in accordance with claim 20, wherein said second conveyor system includes a plurality of retractable fingers at said center exit area to force said material to said third conveying system.
